(19) United States
(12) Patent Application Publication
(10) Pub. No.: US 2018/0218120 A1
(43) Pub. Date: Aug. 2, 2018

(54) System, Method, and Apparatus for Controlling Medical Information

(71) Applicant: Wendy Canzoneri, St. Petersburg, FL (US)

(72) Inventor: Wendy Canzoneri, St. Petersburg, FL (US)

(21) Appl. No.: 15/422,859

(22) Filed: Feb. 2, 2017

(51) Int. Cl. G06F 19/00; G06F 21/62

(52) U.S. Cl. CPC G06F 19/322; G06F 21/6245

(57) ABSTRACT

A system, method, and apparatus for managing medical information includes an application that is run on a device such as a smartphone. The application manages aspects of medical information, keeping track of medical conditions, medications, allergies, insurance policies, permission letters, etc. The application has features that provide for sharing such medical information with others, optionally for limited durations or until the medical information is revoked. The others are, for example, care givers, scout troops, daycare centers, grandparents, etc.

### FIELD

This invention relates to the field of medicine and more particularly to a system for providing medical information in a controlled environment.

### BACKGROUND

Nowadays, almost everybody has a smartphone. Many use their smartphone for messaging, email, taking pictures, etc. In addition, smartphones are used to run applications, often referred to as “apps.” Smartphones have a unique phone number that is one way to address a particular smartphone, for example, to send a message to that particular smart phone.

As capabilities and storage of smartphones has increased, more information has been stored in each user's smartphone, including medical information, insurance policy numbers, etc. Once files are created with such personal information, it is up to the smartphone owner to guard the information. Further, if one shares this information by, for example transferring the information to another in an email message, there is no way to limit the life of the information except by asking the recipient to delete your information.

Another issue occurs when there is an accident such as an automobile, bus, train, plane crash. If any of the occupants of a vehicle in such accident is unconscious or confused, it will be difficult or impossible to obtain critical information from that person such as allergies, blood type, etc. Further, when a family if traveling together and such an incident occurs, if the adults are unconscious or confused, there will be no one to inform medical responders as to any critical information regarding the children such as pre-existing medical conditions (e.g. epilepsy), allergies (e.g. peanuts), blood type, etc.

What is needed is a system that will provide a ubiquitous and unique management of medical information across multiple platforms with emergency access should an accident occur.

### SUMMARY

A system for managing medical information includes an application that is run on a device such as a smartphone. The application manages aspects of medical information, keeping track of medical conditions, medications, allergies, insurance policies, etc. Further, the application has features that provide for sharing such medical information with others such as care givers, scout troops, daycare centers, grandparents, etc.

In one embodiment, a system for managing and sharing medical information includes a plurality of devices for accessing the system for managing and sharing medical information and a server. The server having storage containing a plurality of medical records and the server is connected to the each of the plurality of devices through a network. An application runs on the each of the devices. A first application of such obtains medical information of a person and sends the medical information in a transaction to the sever. Responsive to the transaction, an application running on the server stores the medical information in a first medical record of the medical records in the storage. The first application obtains selections for sharing and obtains an address of a second device and responsive to such, sends a second transaction to the server including the selections for sharing and the address of the second device. Responsive to the second transaction, the application running on the server creates a partial medical record including medical information from the first medical record that is related to the selection and sends the partial medical record to a second application running on the second device, where the second application stores the partial medical record in storage of the second device.

In another embodiment, a method for controlling and sharing medical information includes an application running on a first device sending a share-transaction to a sever, the share-transaction comprising a selection and an address of a second device. Responsive to the share-transaction, the application running on the server extracts medical information from a medical record and creates a partial medical record then sends the partial medical record to a second application running on a second device. The application running on the second device receives the partial medical record and stores the partial medical record in memory of the second device, and then, later, upon the second application receiving a query, the second application displays at least a portion of the partial medical record on a display of the second device.

In another embodiment, program instructions tangibly embodied in a non-transitory storage medium comprising at least one instruction for managing medical information includes computer readable instructions running on a first device obtain a selection and a phone number of a smartphone. Computer readable instructions running on the first device send a first transaction to a sever, the first transaction comprising the selection and the phone number. Computer readable instructions running on the server receive the first transaction and extract a partial medical record from a medical record containing medical information specified by the selection, then send the partial medical record to a smartphone identified by the phone number, and computer readable instructions running on the smartphone receive the partial medical record and upon receiving a query, display at least a portion of the partial medical record on a display of the smartphone.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for controlling medical information.

FIG. 2 illustrates a schematic view of a typical smartphone.

FIG. 3 illustrates a schematic view of a typical computer system such as a server or personal computer.

FIG. 4 illustrates a smartphone user interface for viewing medical information.

FIG. 4A illustrates a smartphone user interface for viewing medical information by a first responder.

FIG. 4B illustrates a smartphone user interface for viewing medical information by a first responder.

FIG. 5A illustrates an exemplary smartphone user interface for accessing the system for controlling medical information to make changes.

FIG. 5B illustrates an exemplary smartphone user interface for updating and sharing medical information in the system for controlling medical information.

FIG. 6 illustrates an exemplary user interface for managing relationships (e.g., family) in the system for controlling medical information n.

FIG. 7 illustrates a dependent record user interface in the system for controlling medical information.

FIG. 8 illustrates a user interface for sharing medical information in the system for controlling medical information.

FIG. 8A illustrates a user interface for revoking previously shared medical information in the system for controlling medical information.

FIG. 9 illustrates a user interface for being invited to access medical information in the system for controlling medical information.

FIG. 10 illustrates a user interface for displaying accessed medical information in the system for controlling medical information.

FIG. 11 illustrates a user interface for displaying medical information in the system for controlling medical information.

FIG. 12 illustrates a user interface for entering medical information in the system for controlling medical information.

FIG. 13 illustrates a user interface for adding a permission letter in the system for controlling medical information.

FIG. 14 illustrates an exemplary set of medical information records in the system for controlling medical information.

FIG. 15 illustrates a connected data graph in the system for controlling medical information.

FIG. 16 illustrates an exemplary program flow in the system for controlling medical information.

FIG. 17 illustrates a second exemplary program flow in the system for controlling medical information.

FIG. 18 illustrates a third exemplary program flow in the system for controlling medical information.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “medical information,” describes data that is stored/transferred containing information of medical nature related to an individual or being (e.g., it is anticipated that information for a pet is also managed). The medical information includes some or all of the following, but is not limited to, medical insurance policy information, dental insurance policy information, vision insurance policy information, automobile insurance policy information, medical conditions, blood type, allergies, preferred hospitals, emergency contacts, contact information for doctors, dentists, etc., restrictions (e.g. no driving at night, no alcohol), etc. Further, the medical information optionally includes other information that is important for providing care, especially in emergency, including any of, but not limited to, date-of-birth, hair color, eye color, height, weight, skin color/tone, distinguishing marks or tattoos, family contacts, other distinguishing information, etc. As will be shown, all such information is useful, especially after an accident when the person is unconscious or confused. Further, the medical information optionally includes any of, but not limited to, sports permission letters, visitation permission letters (e.g., permission for grandchildren to travel with their grandparents or other guardian), permission letters for activities such as girl scouts or boy scouts, letters regarding participation in medical trials, etc.

This description uses the term parent as a user whom manages the medical information of themselves and optionally the medical information of others, for example, others in their family. The term family member will refer to any of such others, for example, a parent of the user who manages the medical information, a spouse of the user who manages the medical information, a child of the user who manages the medical information, a grandchild of the user who manages the medical information, etc. It is fully anticipated that the “others” are, in some embodiments, not family members, for example, a friend's child that visits often, a foster child, a child being mentored (e.g. big-brother or big-sister relationship), etc.

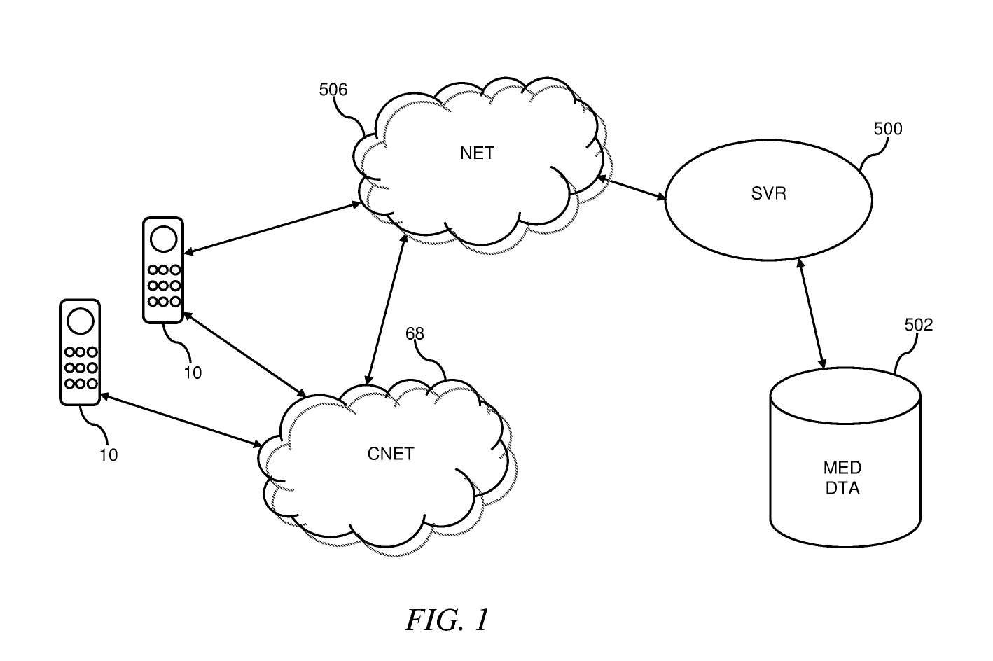

Throughout this description, a smartphone 10 (see FIG. 1) is used as an example of a device on which the system for controlling medical information operates, though it is fully anticipated that any suitable device(s) be used including, but not limited to, tablet computers, laptop computers, portable computers, notebook computers, desktop computers, e-readers, etc.

Referring to FIG. 1 illustrates a data connection diagram of the exemplary system for controlling medical information. In this example, one or more devices such as smartphones 10 communicate through the cellular network 68 and/or through a data network 506 (e.g. the Internet) to a server computer 500.

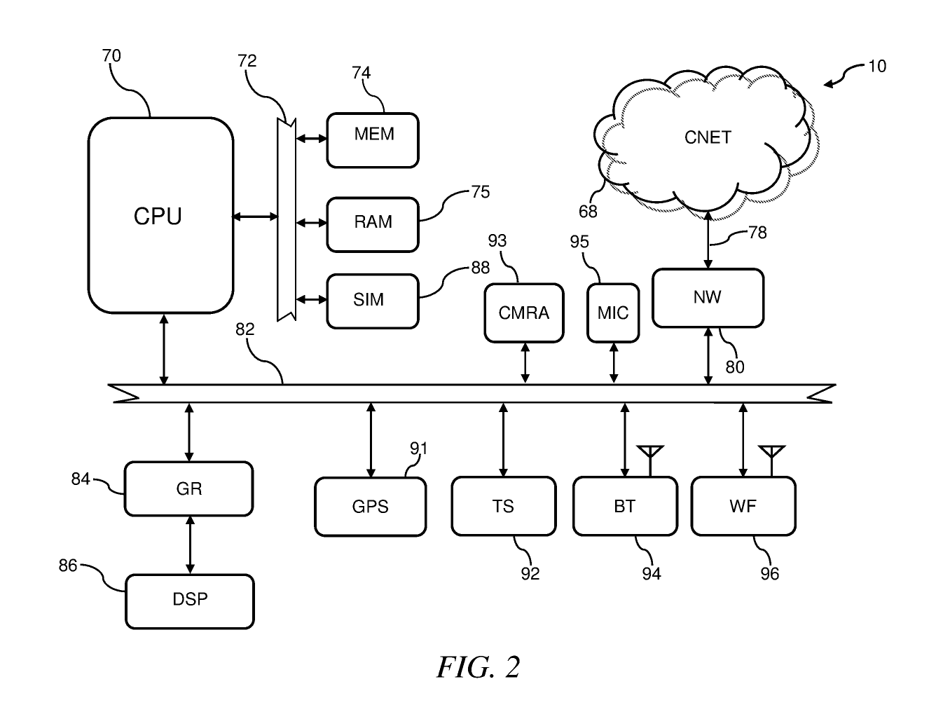

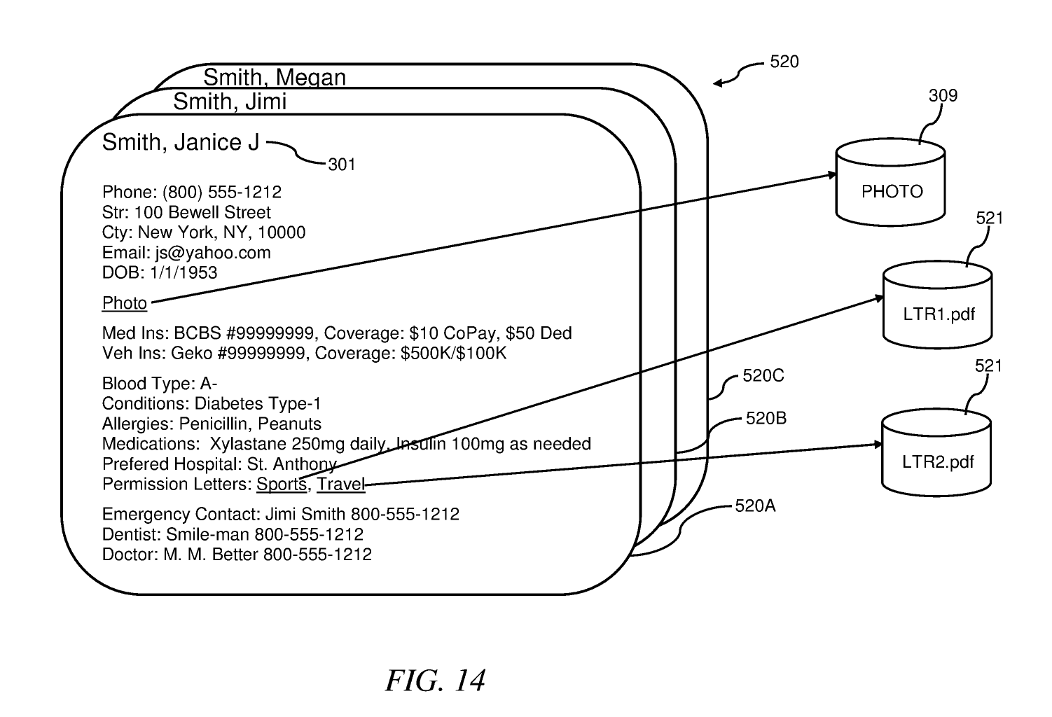

The server 500 has access to data storage 502 that is used to store medical information records 520 (see FIG. 14). Although one path between the smartphones 10 and the server 500 is shown going through the cellular network 68 and the data network 506 as shown, any known data path is anticipated. For example, the Wi-Fi transceiver 96 (see FIG. 2) of the smartphone 10 is used to communicate directly with the data network 506, which includes the Internet, and, consequently, with the server computer 500.

The server 500 transacts with software running on the smartphones 10 through the network(s) 68/506. The software (e.g., an application) present menus to/on the smartphones 10, provides data to the smartphones 10, and communicates information to/from the server such as shared medical information from medical information records 520.

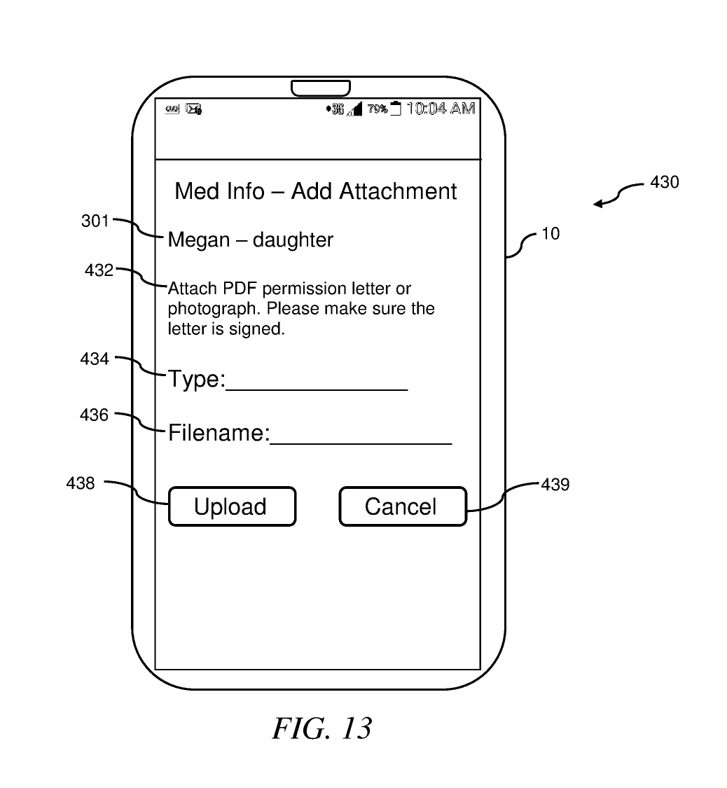

The server 500 transacts with an application running on the smartphones 10 as needed, for example, when downloading a medical information record 520 (see FIG. 13) or updating a medical information record 520. In some areas, smartphone access is sporadic and, being such, the application running on the smartphone downloads and caches all or a subset of the medical information records 520.

In some embodiments, when the system for controlling medical information runs on the smartphone 10, the geographic area of the smartphone 10 is determined by reading the global positioning subsystem 91 (see FIG. 2) of the smartphone 10 or by triangulation with several cellular towers. In some embodiments, the location (e.g. from the global positioning subsystem 91) is used to enhance security by, for example, permitting access to certain parts of the medical information records 520 only in certain locations. For example, if a grandparent has permission to travel with a grandchild within the state of Florida, then the permission letters are not accessible outside of the state of Florida.

In FIG. 1, an exemplary data connection diagram of the system for controlling medical information is shown. The system for controlling medical information, for example, includes a server 500 that transacts with one or more end user devices (e.g. smartphones 10) to manage medical information records 520.

The system for controlling medical information stores medical information records in a records database (e.g. in a data storage 502 that is local to the server 500, cloud-based storage, etc.). In this example, medical information records 520 or partial medical information records 520A are communicated between the server 500 and end-user devices (e.g. smartphones 10) through a network 68/506. Any network topology and composition is fully anticipated including only a data network 508 (e.g. the Internet) or only the cellular network 68 (e.g. sending medical information records 520 using Short Message Services—SMS).

Referring to FIG. 2, a schematic view of a typical end-user device, a smartphone 10 is shown. Although any end-user device is anticipated, for clarity purposes, a smartphone 10 will be used in the remainder of the description.

The system for controlling medical information is described using a processor-based end-user device (e.g., smartphone 10) for providing the login and user interfaces necessary for managing medical information and using an application to access medical information records 520, for example, a guardian accessing medical information records of one who is under their care. The present invention is in no way limited to using a smartphone 10 and any similar device is anticipated (e.g., cellular phone, portable digital assistant, tablet computer, notebook computer, etc.).

The example smartphone 10 represents a typical device used for accessing user interfaces of the system for controlling medical information. This exemplary smartphone 10 is shown in its simplest form. Different architectures are known that accomplish similar results in a similar fashion and the present invention is not limited in any way to any particular smartphone 10 system architecture or implementation. In this exemplary smartphone 10, a processor 70 executes or runs programs in a random-access memory 75. The programs are generally stored within a persistent memory 74 and loaded into the random-access memory 75 when needed. Also, accessible by the processor 70 is a SIM (subscriber information module) card 88 having a subscriber identification and often persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro SD cards, compact flash, etc.

Also, connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the SIM card 88 is used to store programs, executable code, cached medical information records 520, and data, etc. In some embodiments, other data is stored in the persistent memory 74 such as audio files, video files, text messages, etc.

The peripherals are examples and other devices are known in the industry such as global positioning subsystem 91, speakers, microphones, USB interfaces, camera 93, microphone 95, Bluetooth transceiver 94, Wi-Fi transceiver 96, image sensors, temperature sensors, etc., the details of which are not shown for brevity and clarity reasons.

The cellular network interface 80 connects the smartphone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the smartphone 10 through the cellular network 68.

For local communications, many smartphones 11 include a Bluetooth transceiver 94, a Wi-Fi transceiver 96, or both. Such features of smartphones 10 provide data communications between the smartphones 10 and data access points and/or other computers such as a personal computer (not shown).

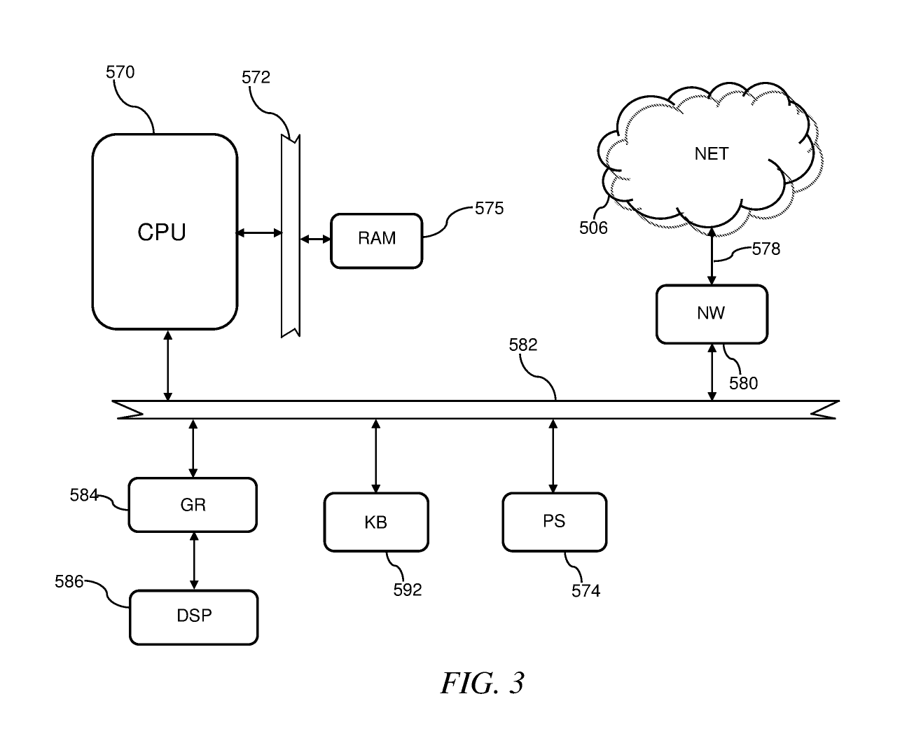

Referring to FIG. 3, a schematic view of a typical computer system (e.g., server 500) is shown. The example server 500 represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed.

The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, partial medical information records 520A or complete medical information records 520, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

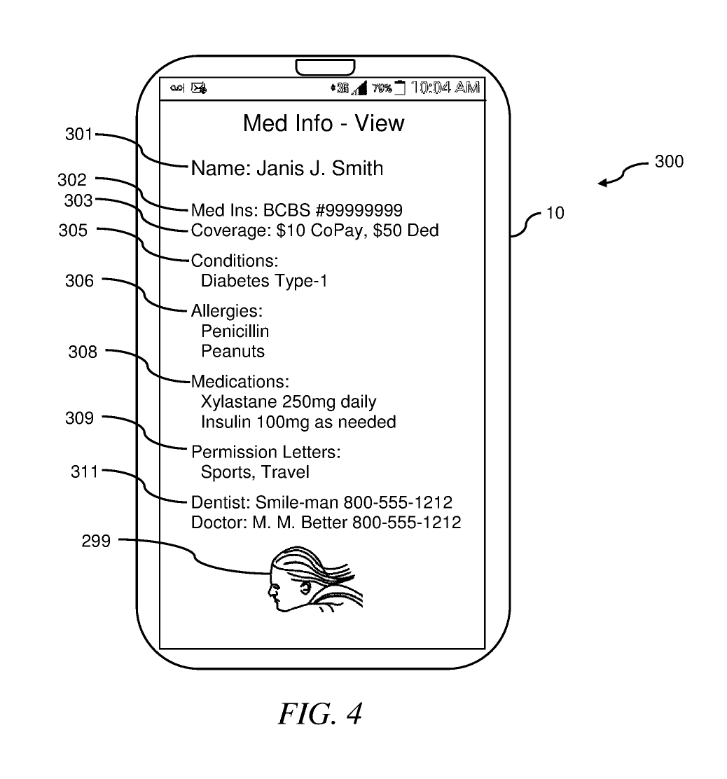

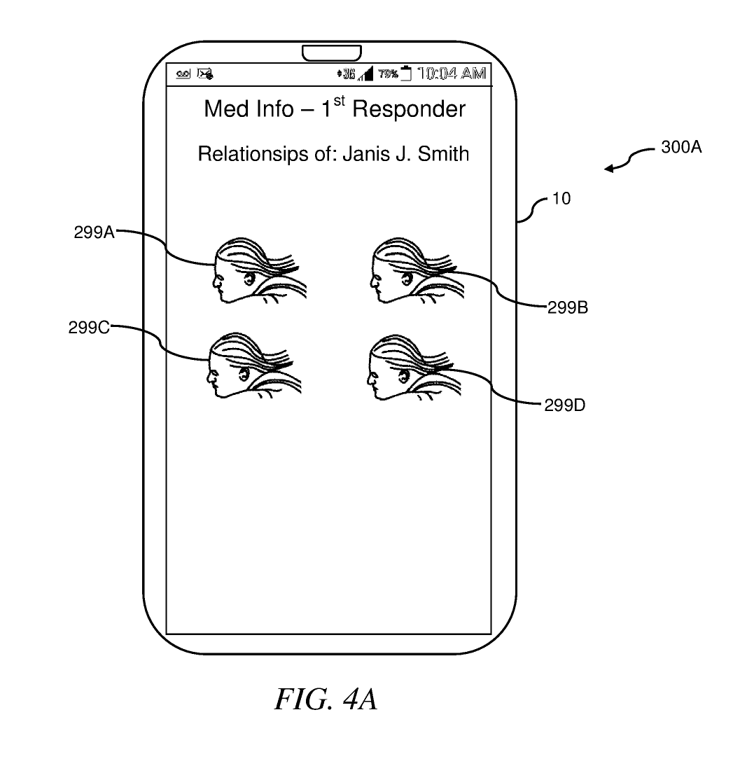

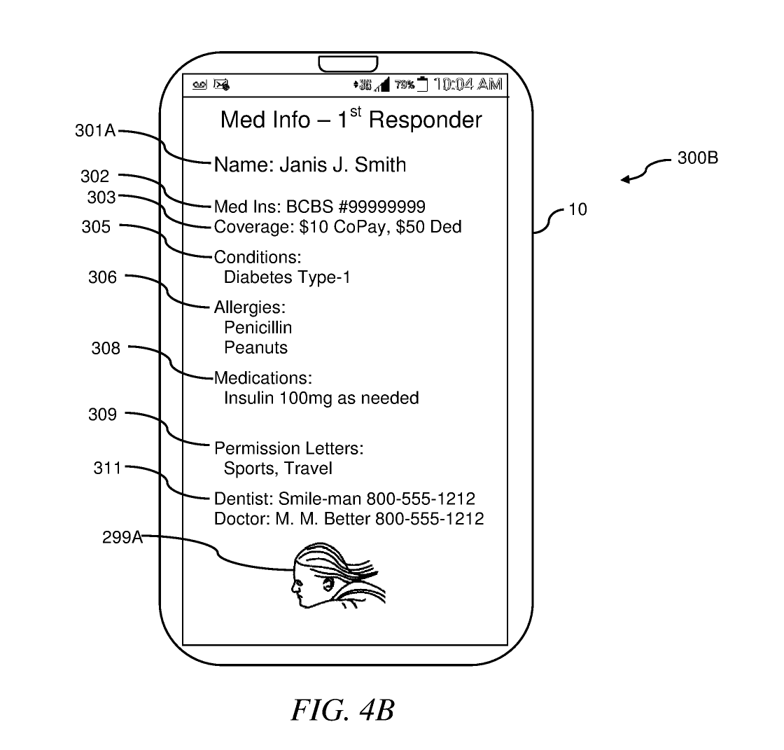

Referring to FIG. 4, a representative user interface for viewing medical information 300 of the system for controlling medical information is shown. In this, the name 301 of the person to which the medical information pertains is displayed. As discussed, it is anticipated that many different data be maintained in the medical information records 520 and, for clarity and brevity purposes, only some of the anticipated data is shown in FIG. 4 and the remainder of this specification. It is fully anticipated that multiple pages, scrolling, etc., are used to display the full or partial sets of medical information from the medical information records 520.

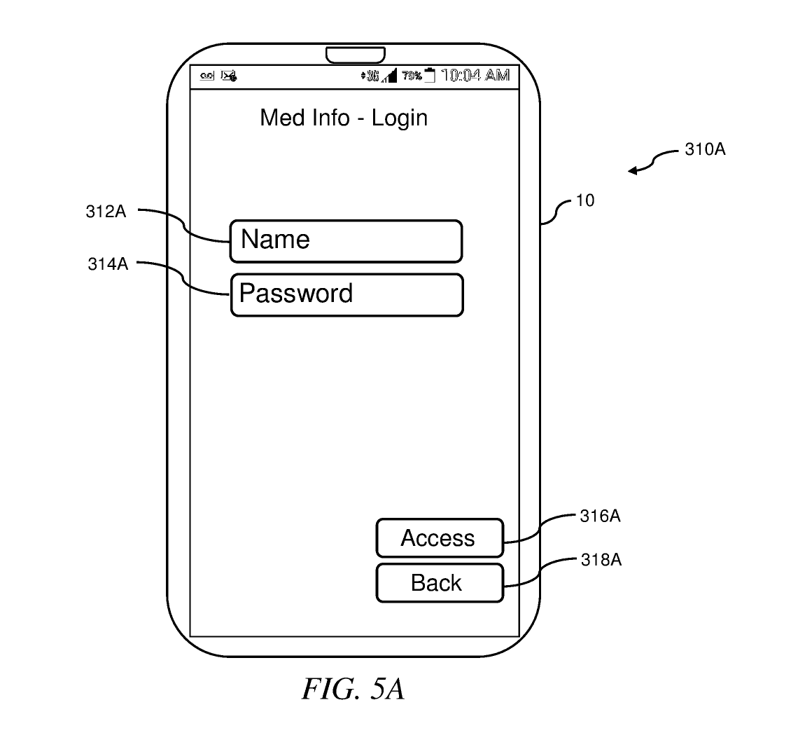

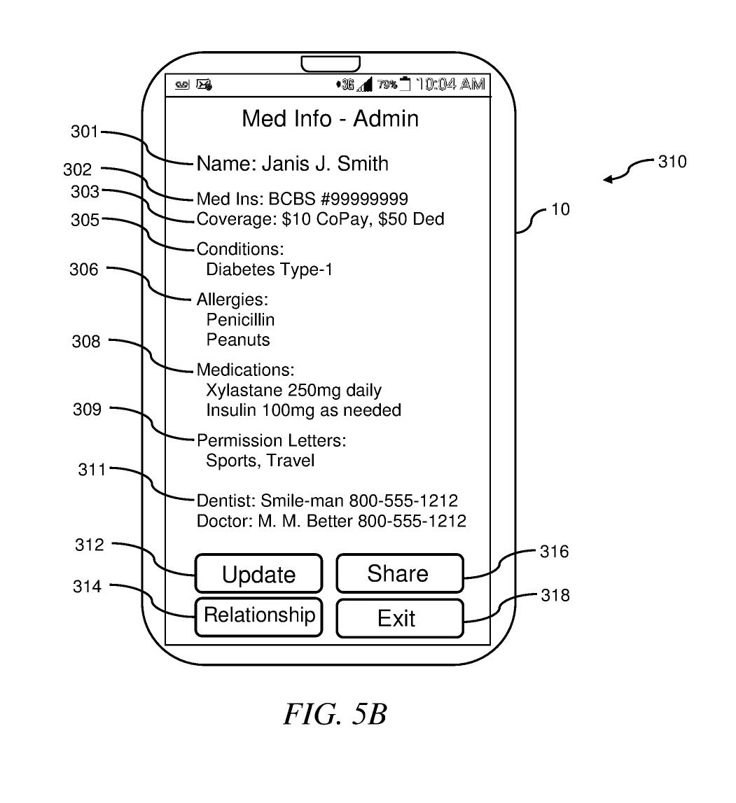

In the user interface for viewing medical information 300 of FIG. 4, medical insurance information 302 is displayed (e.g., company and policy number), medical insurance policy coverage 303, medical conditions 305 (e.g. chronic illnesses), allergies 306, medications 308, links to permission letters 309, contact information 311 for doctors and dentists, and a photo 299 of the person to which the medical information pertains. The photo 299 as well as other identification information (e.g., eye color, hair color, skin tone/color, distinguishing marks/tattoos, etc.) will be useful should there be an accident and the person, being unconscious, needs to be identified to make sure the device (e.g., smartphone 10) and/or medical information record 520 pertains to that person. In some embodiments, before allowing the full set of medical information to be displayed as in FIG. 4, the user must pass a security verification as shown in FIG. 5A.

Referring to FIGS. 4A and 4B, a smartphone user interface for viewing medical information by a first responder 300A/300B are shown. In the past, some individuals maintained some amount of information on their smartphones 10, but for privacy and security reasons, often such phones were locked needed in pin, password, fingerprint, or pattern to unlock the smartphone 10. In some embodiments of the present invention, first responders have interfaces to some or all of the medical information through an unlocked screen accessed through a soon-to-be well known method such as triple clicking of the power button or pressing the power button then pressing volume up and down at the same time, etc.

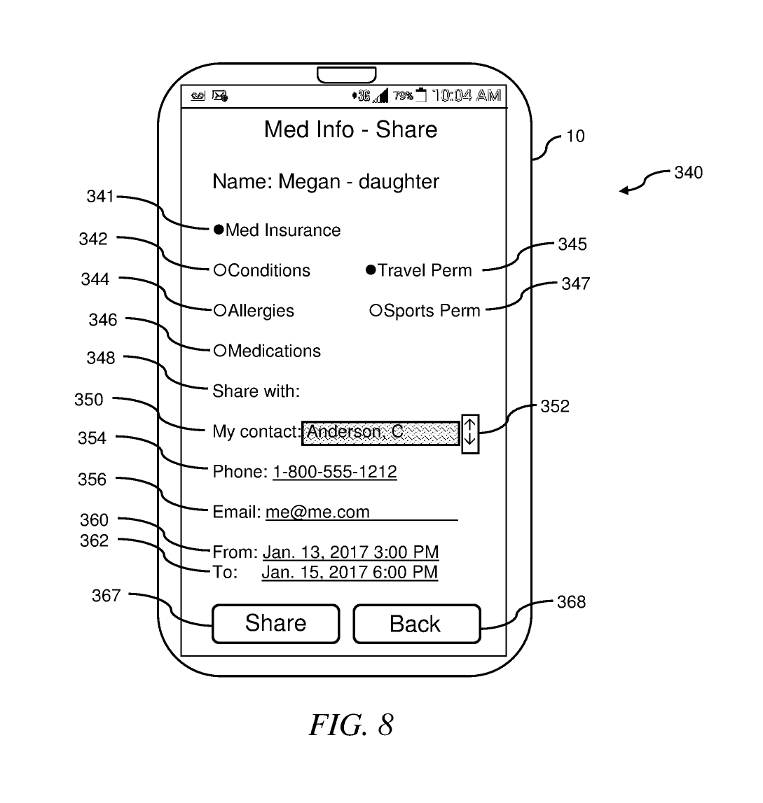

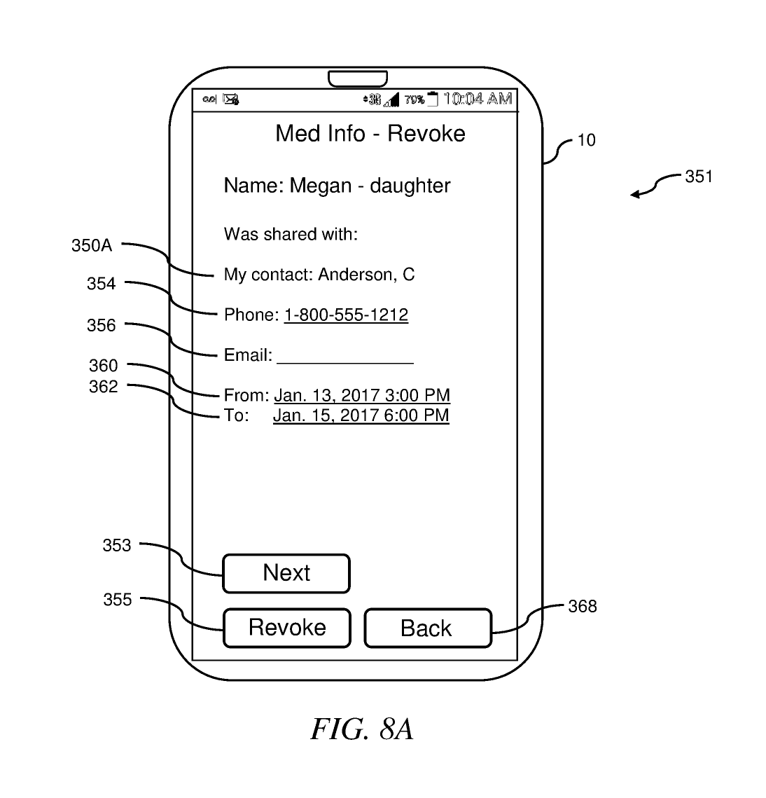

Since the first responder will not know the user's password, etc., the first responder access is made without requiring a password, but the information presented (see FIG. 4B) is selectable to redact any information that is sensitive. For example, in FIG. 4B, the medication Xylastane is not shown in the field for medications 308, as this (fictitious) medication is for treatment of a condition that is not important for a first responder (e.g., erectile dysfunction, psoriasis, hair loss, etc.). The subset of information that is provided to first responders is selected in a user interface such as that shown in FIG. 8.

Also, it is anticipated that first responders be provided with a device (“what they have”) that provides security access to the user's medical information. For example, the first responders are provided with a key-fob that has a Bluetooth transmitter that, upon attempting to access the user's medical information (e.g., triple-pressing the power button), the smartphone 10 of the user, the system for controlling medical information attempts a connection the key-fob and, only when the connection succeeds, displays the provided medical information. Note, in some such embodiments, each key-fob is encoded with a serial number that is traceable back to the first responder to provide accountability for each access to medical information.

Once access has been made, the exemplary user interface for viewing medical information by a first responder 300A is displayed showing, for example, images 299A/299B/299C/299D of each person for which data is available. Note that, as it is sometimes difficult to identify a person solely by an image, in some embodiments, additional identifying information (e.g., eye color, hair color, skin tone/color, distinguishing marks/tattoos, etc.) is provided along with each image 299A/299B/299C/299D. By selecting one of the images 299A/299B/299C/299D, a medical information display 300B user interface is displayed as shown in FIG. 4B, for example, showing medical information of Janis J. Smith 301A related to the first image 299A.

Referring to FIG. 5A, an exemplary smartphone user interface for accessing 310A the system for controlling medical information to make changes is shown. As there are many concerns with sharing medical information, it is anticipated that before allowing access and making changes to the full set of medical information, the user needs to provide security credentials as shown in the exemplary smartphone user interface for accessing 310A as in FIG. 5A or any other form of verification as known in the industry. The simplified user interface for accessing 310A requests a user name 312A and a password 314A. After entering the user name 312A and a password 314A, the user selects the Access function 316A to access and/or edit the full set of medical information. The user interface for accessing 310A also has a Back directive 318A should the user decide to cancel and not access the full set of medical information. Note that a user name 312A and a password 314A is used in this example, though any form of security is anticipated including, but not limited to, a fingerprint, facial recognition, an external device (e.g., key-fob) with rolling code, etc. This security step is also advantageous to parents who allow children to use a smartphone 10 of the parent to play games, etc.

Referring to FIG. 5B, an exemplary smartphone user interface for updating and sharing medical information 310 in the system for controlling medical information is shown. As in the viewing medical interface 300, in this user interface, the name 301 of the person to which the medical information pertains is displayed. As discussed, it is anticipated that many different data be maintained in the medical information records 520 and, for clarity and brevity purposes, only some of the anticipated data is shown in FIG. 5B and the remainder of this specification. In the user interface for updating and sharing medical information 310 of FIG. 5B, medical insurance information 302 is displayed (e.g., company and policy number), medical insurance policy coverage 303, medical conditions 305 (e.g. chronic illnesses), allergies 306, medications 308, links to permission letters 309, contact information 311 for doctors and dentists, and a photo 299 of the person to which the medical information pertains. The photo 299 as well as other identification information (e.g., eye color, hair color, skin tone/color, distinguishing marks/tattoos, etc.) will be useful should there be an accident and the person, being unconscious, needs to be identified to make sure the device (e.g., smartphone 10) and/or medical information record 520 pertains to that person.

In this interface, an update directive 312 is provided for updating the medical information for the person. A family directive 314 is available for updating family records and/or relationships (e.g., upon marriage, divorce, birth, death, adoption, etc.). A share directive 316 is provided for sharing medical information with others, and an exit directive 318 is provided for exiting from the system for controlling medical information application.

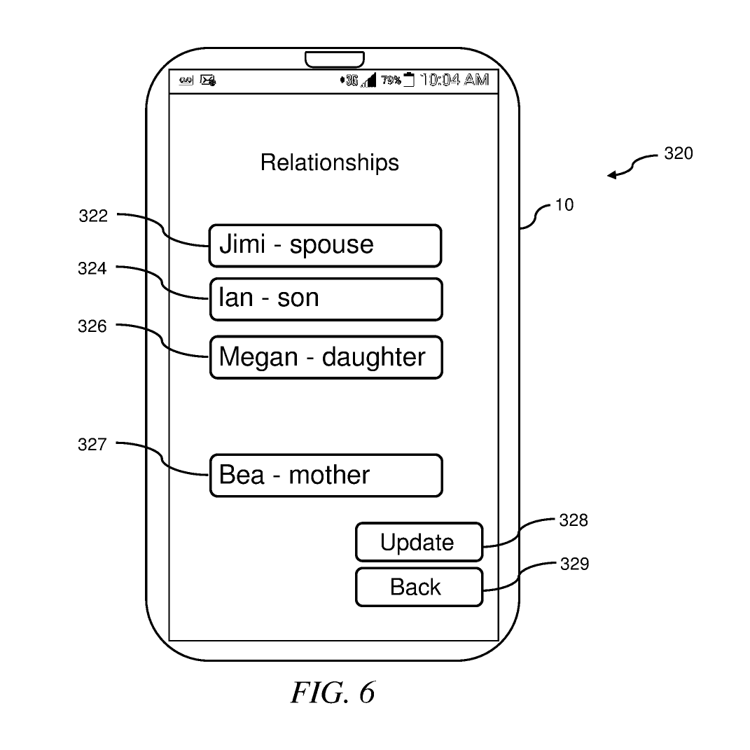

Referring to FIG. 6, an exemplary user interface for managing relationships 320 (e.g., family) in the system for controlling medical information is shown. In this, other family members (or relationships) are shown, for example, a spouse 322 and two children 324/326. In situations in which a parent or other is the care of the primary person, a link 327 to that person is also shown. By selecting any of the family member directives 322/324/326/327, medical information as in FIGS. 4 and 5 is shown for that family member. To make changes to relationships (e.g., upon marriage, divorce, birth, death, adoption, etc.), an update directive 328 is provide. To return back to the previous user interface, a “back” directive 329 is provided.

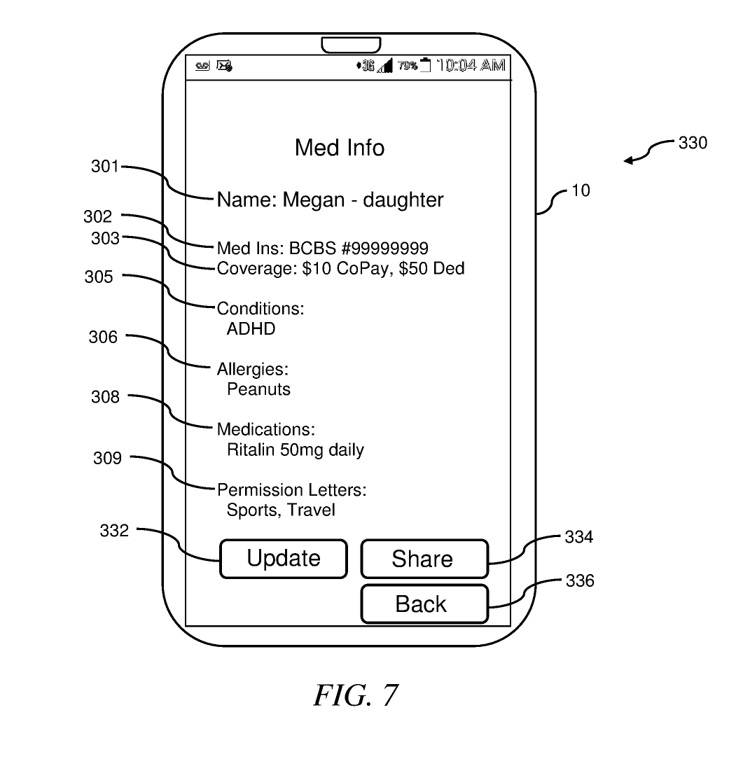

Referring to FIG. 7, a dependent record 330 user interface in the system for controlling medical information is shown. When any of the family member directives 322/324/326/327 are selected, the dependent record 330 user interface is presented for that family member. The dependent record 330 user interface includes information for a dependent of the primary person, in this case a child, including the name 301, medical insurance numbers 302 and medical insurance policy coverage 303, medical conditions 305, allergies 306, medications 308, permission letters 309, etc. An update directive 332 is provided for making changes to this family member's record. A back directive 336 is provided for reverting back to the previous user interface. A share directive 334 is provided for sharing some or all of the medical information of this family member with another as is described in FIG. 8.

Referring to FIG. 8, a user interface for sharing 340 medical information in the system for controlling medical information is shown. In this, it is desired to share the medical information of one family member, in this example, a child, with another person. This is useful when the family member will be in the temporary care of another such as another family member (e.g., grandparent, cousin, aunt, uncle), when the child takes part in certain sport activities, when the child is away at camp or a field trip, etc. The user interface for sharing 340 provides directives for selecting which medical information of the family member is shared, time frames for which the information is shared, and identification information of the person with whom the medical information is shared. Again, as with the prior user interfaces, the categories of medical information that are selectable are abbreviated for clarity and brevity reasons. For example, there are radio buttons for medical insurance 341, medical conditions 342, allergies 344, and medications 346. There are also radio buttons for including the travel permission slip 345 and/or the sports permission slip 347. By selecting (darkening) the corresponding radio button, that information is included with the information provided to the recipient.

The “share with” section 348 includes one or more ways to identify the person with whom this medical information will be shared. For example, a my contact selection 350 is provided to scroll through an address book, for example, using an up/down scroll 352 or any other user interface. Alternately, a phone number is entered into the phone number field 354 or an email address is entered into the email field 356. Any type of addressing or identifying the recipient is anticipated. For example, in a closed system for controlling medical information, each user and/or possible recipient of medical information has a unique username or identification number that uniquely identifies that person for reception of medical information from another.

In some embodiments, once medical information is shared with another, should updates be made to the medical information record 520 (e.g., an additional medical condition, allergy, etc.), the updated medical information is synchronized with any user to which that medical information has been shared.

Once medical information is shared with another, the initiator had the ability to recall that information (e.g., revoke the ability for that person to access the previously shared medical information) as shown in FIG. 8A. Alternately, the initiator has the ability to limit access to the medical information for a specific date/time range. In the exemplary user interface for sharing 340, a date/time range is specified by entering a start time/date (“From” 360) and/or an end time/date (“To” 362). For example, if wanting to provide the medical information to the recipient until Sunday at 5:00 PM, only the “To” 362 end time/date is entered (e.g., Sunday, 5:00 PM) and no “From” 360 time/date is entered. Any other time/date/period data entry is anticipated such as calendar entry directives, periods of time (e.g., 10 days), etc., and the present invention is not limited in any way to any specific method of entering a date/time or period. By leaving the start date/time (“From” 360) empty, the medical information is available immediately to the person with whom this medical information will be shared. By leaving both the start date/time (“From” 360) empty and the end time/date (“To” 362) empty, the medical information is available immediately to the person with whom this medical information will be shared an will be available until revoked/rescinded.

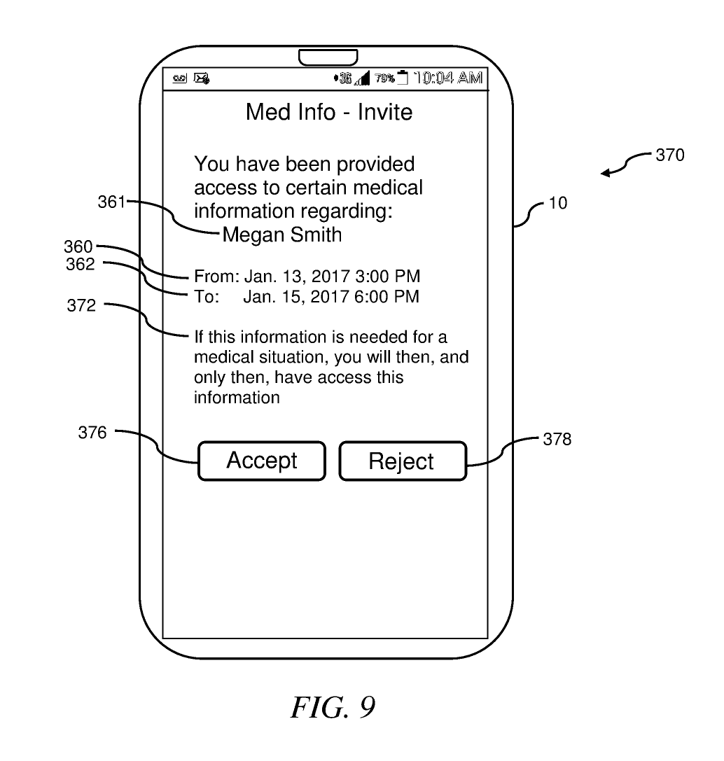

Once the medical data to share is selected, the recipient is selected, and the optional time period is selected, the “share” directive 367 is operated/selected and the selected medical information is packaged and sent to the recipient as described in FIGS. 9 to 11. A back directive 368 is provided should the initiator decide to not to share medical information at this moment.

Referring to FIG. 8A, a user interface for revoking 351 previously shared medical information in the system for controlling medical information is shown. The user interface for revoking 351 includes the name associated with the medical information and the selected one or more ways to identify the person with whom this medical information was shared. For example, a contact selection 350A, a phone number in the phone number field 354 or an email address in the email field 356. Any type of addressing or identifying of the recipient is anticipated. If a date/time range was specified, the time/date (“From” 360) and/or an end time/date (“To” 362) are displayed as well.

The user has a next directive to view a next sharing record (if other sharing records are active) and a back directive 368 to cancel the revoke action. After review of the sharing record as displayed in FIG. 8A, if the user decides that the recipient no longer should have access to the medical information previously provided, the user selects the revoke directive 355 and the medical information provided to the recipient is erased from the smartphone 10 of the recipient and is made unavailable to the recipient.

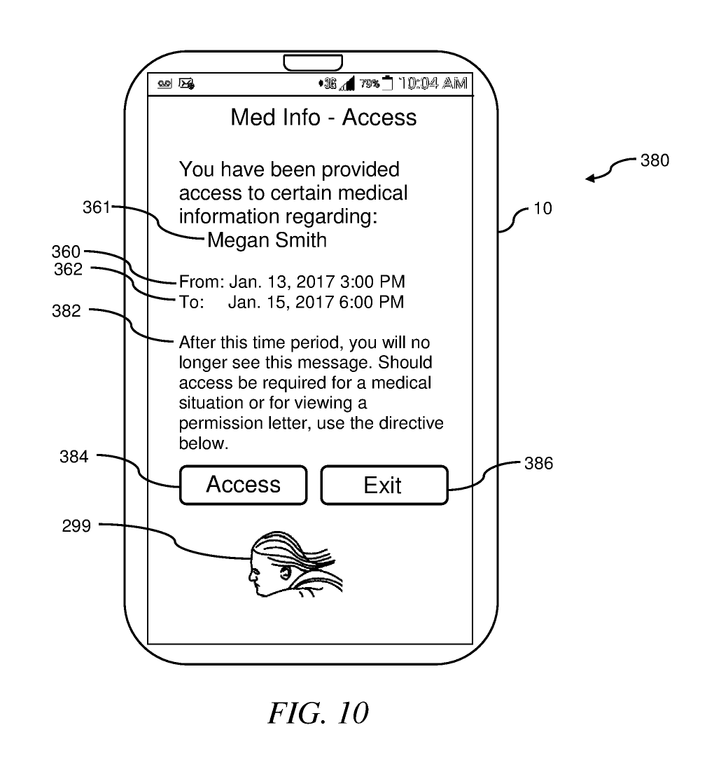

Referring to FIG. 9, a user interface for being invited to access 370 medical information in the system for controlling medical information is shown. After the initiator shares some or all medical information for a specific family member (or self) with a recipient, optionally, the recipient is invited to accept receipt of the medical information using, for example, using the user interface for being invited to access 370 medical information. The user interface for being invited to access 370 medical information identifies the name 362 of the person to which the medical information pertains, the date/time range 360/362 of which the medical information is available, and any informational or warning messages 372 needed—for example, explaining the sensitivity of the information and that it should only be accessed if needed. In this optional user interface, the recipient has the ability to accept 376 the medical information or reject 378 the medical information. If the recipient invokes the reject 378 the medical information, a message is sent back to the initiator informing the initiator that the recipient does not accept the medical information. If the recipient accepts 376, a user interface for providing access 380 to the medical information is presented as in FIG. 10.

Referring to FIG. 10, a user interface for providing access 380 to the medical information in the system for controlling medical information is shown. The user interface for providing access 380 to the medical information displays the name 361 of the person to which the medical information pertains, the date/time range 360/362 of which the medical information is available, and any informational or warning messages 382 needed, for example a warning to only access the medical information when needed. The recipient has an access directive 384 for accessing the medical information should a need arise and an exit directive 386 to exit when needed. In some embodiments, an image 299 of the person to which the medical information pertains is displayed so the recipient can be able to identity that person should an emergency occur, etc. Further, in some embodiments, other identifying information is displayed such as hair color, eye color, skin color/tone, identifying marks/tattoos, etc.

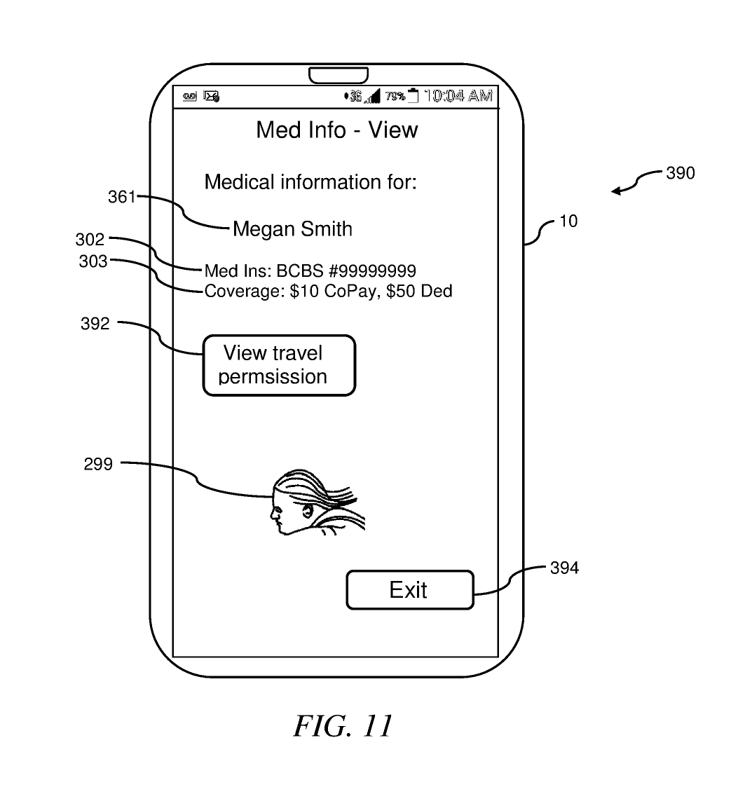

Referring to FIG. 11, a user interface for displaying 390 medical information by a recipient in the system for controlling medical information is shown. When a need arises for such medical information or permission letter and the access directive 384 of the previous user interface is selected, the user interface for displaying 390 medical information presents the medical information that was included. In this example, the name 361 of the person is provided and the limited amount of medical information includes medical insurance information 302, medical insurance policy coverage 303, and a directive for viewing 392 a travel permission letter is provided. In some embodiments, an image 299 or other identifying information is provided as well as an exit directive 394. In some embodiments, after the access directive 384 is selected, a notice is sent to the primary user (e.g., an email, text message, voice message, etc.) to inform the primary user of such access (e.g. an emergency is possible . . . ). It is also anticipated that instead of a single access directive 384, in some embodiments multiple access directives are provided, for example, one access directive for medical information (which, in embodiments with notifications, a notification is made), another access directive for allergies (e.g. to warn not to feed peanuts . . . ), and another access directive for permission slips (e.g. to print or copy a permission slip or to make sure participation in a sport activity is possible . . . ).

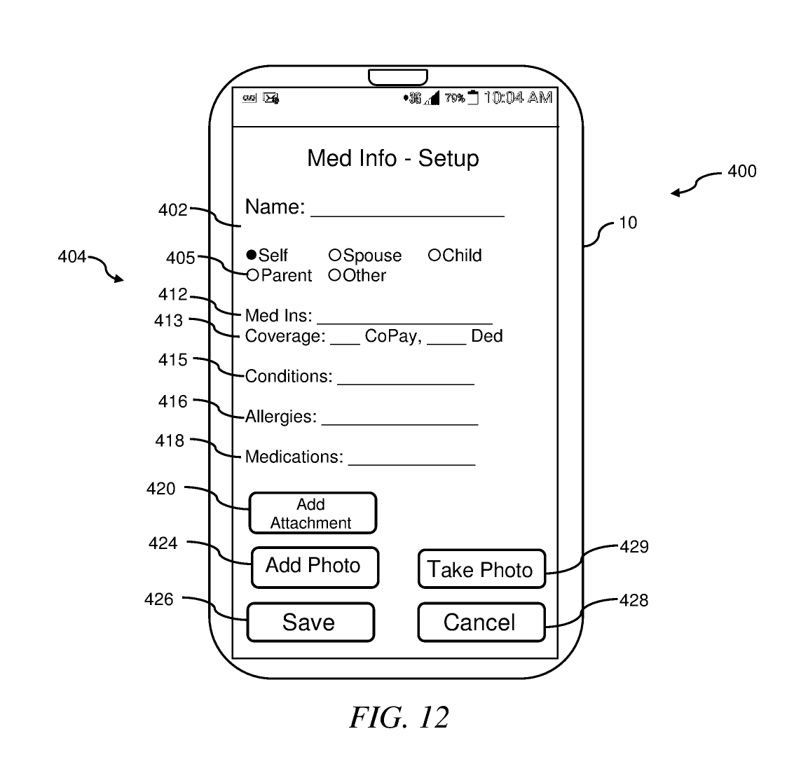

Referring to FIG. 12, a user interface for entering or updating 400 medical information in the system for controlling medical information is shown. For each user (e.g., primary, family members, etc.) identification information is provided, including, for example, a name 402, a photo/image 424, and other identifying information such as hair color, eye color, skin color/tone, distinguishing marks/tattoos, etc. (not shown for brevity and clarity). In some embodiments, the user interface for entering or updating 400 medical information includes a way to enter how this person is related to the primary family member, for example radio buttons 405 indicating self, spouse (significant other), child, parent, etc. Other fields are provided to enter medical information, for example, but not limited to, medical conditions 415, allergies 416, medications 418, etc.

To add an attachment such as any type of letter, message, permission-slip, copies of insurance cards, an image of a medication label, copy of passport, copy of driver's license, etc., an add attachment directive 420 is provided. Likewise, an add-photo directive 424 is provided. Again, as any other information is to be added to the medical information record 520, user interface fields, selections, and directives are provided on the entering/updating user interface for entering or updating 400 as needed (e.g., other medical information, identifying information, etc.). Further, it is fully anticipated that the entering/updating user interface for entering or updating 400 is presented on multiple pages as needed. It is also envisioned that the user has the ability to take a picture using the “take photo” directive 429 which, when selected, initiates the photo taking application that accesses the camera 93 of the smartphone 10 to capture an image of the person of the current record, which is subsequently linked to the current medical information record 520.

In some embodiments, expiration dates of insurance policies are also entered with the medical information and, upon or before such expiration dates, reminders are made to renew and/or update insurance information. In some embodiments, a reminder is also made on the birthdate of certain family members (e.g. children) to update the image 299 of that family member, as certain family members often change year-to-year.

Once information has been entered, the “save” directive 426 is selected. To exit without changes, the “cancel” directive 428 is selected.

Referring to FIG. 13, a user interface for adding 430 a permission letter in the system for controlling medical information is shown. Any type of letter, message, permission-slip, copies of insurance cards, an image of a medication label, copy of passport, copy of driver's license, etc., is anticipated. The name 301 of the person that the medical information pertains is displayed along with instructions 432 and a field to enter the type of attachment 434 (e.g. travel permission, grandparent permission, passport, etc.). Many user interfaces are known for attaching a file (e.g., a PDF letter) to a record and the user interface shown in FIG. 13 is one sample, as other, more complex user interfaces with browse abilities are fully anticipated.

Once the type of attachment 434 and filename 436 are entered, an upload directive 438 is selected to initiate uploading of the attachment to the medical information record 520. If it is decided not to attach a file at this time, the cancel 439 directive is selected.

In FIG. 14, an exemplary set of medical information records 520 as stored in data storage 502 are shown. In this simplified example, only three medical information records 520 are shown, a first record 520A for Janice J. Smith, a second record for Jimi Smith 520B, and a third record 520C for Megan Smith. Note that these medical information records 520 contain the information that has been entered using the above, exemplary user interfaces or any other user interface, for example, a user interface provided through a browser. The first record 520A, which is fictitious, included the medical information of Janice J. Smith including, for example, insurance information, blood type, allergies, medical conditions, preferred hospitals, emergency contact information, dentist/doctor information, etc. Again, it is fully anticipated that in some embodiments, more or less medical information is provided and more or less fields for containing such information are provided as well. It us further anticipated that other information be provided in the medical information records 520. For example, information regarding food preferences, music preferences, etc., is provided as, for example, children are often in the care of others who are not fully familiar with such other information. Likewise, although certain information is needed, for example, the name 301 associated with the first medical record 520A, much of the medical information is optional as, for example, some individuals do not have allergies or do not take any medications, etc.

As attachments are added as in FIGS. 12 and 13, the attachment files 299/521 are saved in the data storage 502 and links to the attachment files are made from the medical information records 520.

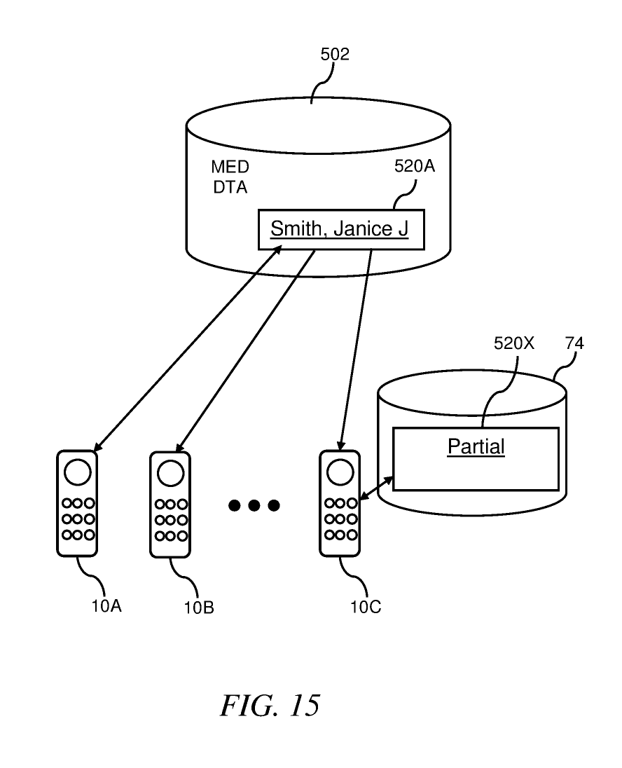

In FIG. 15, a connected diagram is shown with multiple devices 10A/10B/10C using an application of the system for controlling medical information, stored, for example, in the data storage 502. The first medical record 520A in the data storage 502 contains all medical information entered regarding the user (e.g., Janice J. Smith). Three devices 10A/10B/10C are shown for brevity reasons, although any number of devices (e.g. smartphones 10) are anticipated.

Being that the first medical record 520A contains all medical information regarding the user associated with that first medical record 520A (e.g., Janice J. Smith), no direct access to the first medical record 520A is allowed. Instead, when part or all of the medical record is shared with a recipient, only the information that is provided/allowed by the owner of the first medical record 520A (e.g., owner, parent, spouse, etc.) are shared with the recipient (e.g. a partial medical record 520X). In some embodiments, the partial medical record 520X, extracted from the first medical record 520A, is downloaded and stored in the persistent memory 74 of the smartphone 10. In other words, the extracted parts and/or attachments of the first medical record 520A are downloaded and stored at the recipient's device 10C. Therefore, the recipient's device 10C will have access to all included medical information that was extracted from the user's medical information (first medical record 520A), even if data access to the server 500 is not available, as often happens during camping or excursions that are not in range of the cellular or Wi-Fi networks. When the owner of the first medical record 520A updates information in the first medical record 520A, updates to the extracted partial medical record 520X are made and sent to the recipient's device 10C. In some embodiments, if the owner of the medical information records 520A revokes the sharing with the recipient's device 10C, a transaction is sent to the recipient's device and the extracted partial medical records 520X is erased from the recipient's device 10C.

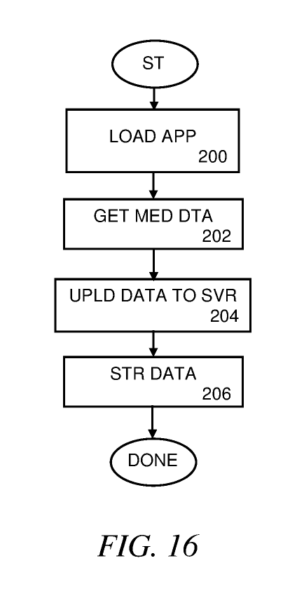

Referring to FIGS. 16-18, exemplary program flows of the system for controlling medical information are shown.

It is anticipated that portions of the exemplary program flow execute on a user device such as a smartphone 10 while portions of the exemplary program flow execute on the server 500.

In this example, the flow starts when the primary or other user creates or modifies their medical information record 520 or a medical information record 520 of a family member, etc., as for example, using an interface such as the user interface for entering or updating 400 shown in FIG. 15. The smartphone application is loaded 200, as known in the industry. The application starts by obtaining 202 medical information for one or more family members. The medical information is uploaded 204 to the server 500 and the server stores 206 the medical information record 520 in the data storage 502 along with any attachments 521, images 299, etc.

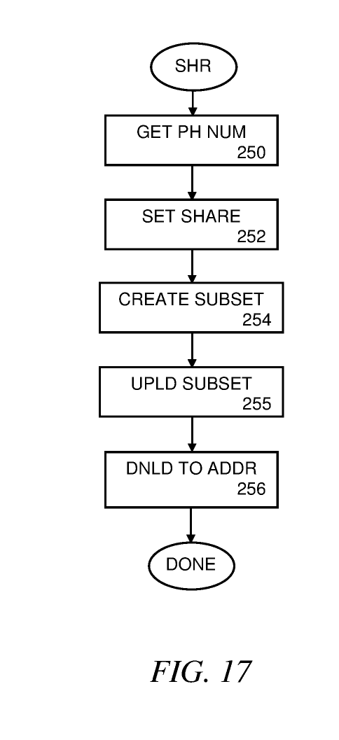

When the primary or owner of the medical data record shares some or all of a medical information record 520 with a recipient (as in FIGS. 8-12), the first step (as shown in FIG. 17) is to obtain 250 an address or the recipient of the medical information, for example, a phone number of the recipient, an email address of the recipient, a name of the recipient, a serial number of the recipient, etc. Next, the user enters/selects 252 which information of the medical information record 520 is to be shared (e.g., only medications and allergies). Next, the address of the recipient and selections are created 254 then uploaded 255 to the server 500 and a partial medical record 520X is created 254 from the medical information record 520 using the selections made by the user when the user entered/selected 252 which information of the medical information record 520 is to be shared. It is fully anticipated that any or all of the medical information record be inserted into the partial medical record 520X. It is also anticipated that part of specific fields be redacted before insertion into the partial medical record 520X. For example, redaction of one medication from the medication field 308 as shown in FIG. 4B.

In some embodiments, the partial medical information record 520X is stored in the data storage 502. Next, the recipient accesses the server 500, and the subset of the partial medical record 520X is downloaded 256 to the address provided (e.g. to recipient's device 10C) and, in some embodiments, stored in the persistent memory 74 of the smartphone 10.

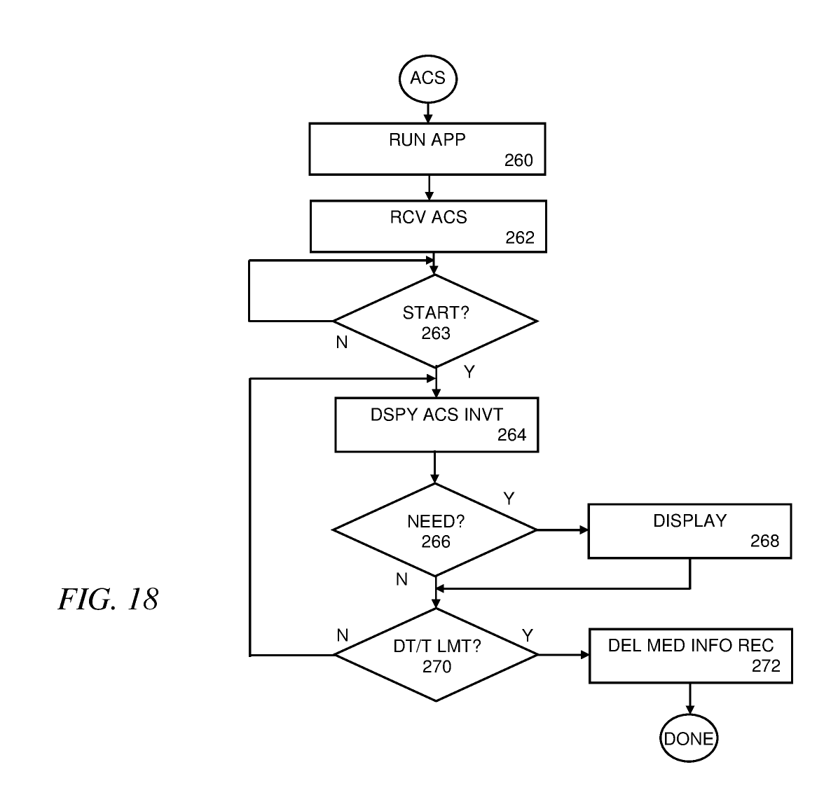

In FIG. 18, it is shown what happens at the smartphone 10 of the recipient. The application is run 260 and the partial medical record 520X is received 262. In some embodiments, access to the partial medical information record 520X is not allowed until the start 263 date/time. The invitation is then displayed 264 and if the recipient has need to view 266 the partial medical record 520X, the information in the partial medical record 520X is displayed. Once the date/time limit is reached 270, the partial medical record 520X is deleted 272 from the smartphone 10

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for managing and sharing medical information, the system comprising:
a plurality of devices for accessing the system for managing and sharing medical information;
a server, the server having storage containing a plurality of medical records, the server connected to the each of the plurality of devices through a network;
an application running on the each of the devices; a first application of the applications running on each of the devices obtains medical information of a person and sends the medical information in a transaction to the sever, responsive to the transaction, an application running on the server stores the medical information in a first medical record of the medical records in a storage interfaced to the server;
the first application obtains selections for sharing and obtains an address of a second device of the devices and responsive to such, sends a second transaction to the server including the selections for sharing and the address of the second device; and
responsive to the second transaction, the application running on the server creates a partial medical record including medical information from the first medical record that is related to the selection and application running on the server sends the partial medical record to a second application running on the second device, where the second application stores the partial medical record in storage of the second device.

2. The system of claim 1, whereas the second transaction further comprises at least one restriction for limiting access to the partial medical record for a date/time range.

3. The system of claim 2, whereas after the date/time range expires, the partial medical record is erased from the storage of the second device.

4. The system of claim 1, whereas upon a request of a user of the second device, the application running on the second device displays at least a portion of the partial medical record from the storage of the second device.

5. The system of claim 1, whereas upon an update made to the first medical record using the first application, the first application sends a third transaction to the server including the update; responsive to the third transaction, the application running on the server updates the first medical record and updates the partial medical record including the update and the application running on the server sends the partial medical record to an application running on the second device, where the application running on the second device stores the partial medical record in the storage of the second device.

6. The system of claim 1, whereas upon a request to rescind the partial medical record using the first application, the first application sends a fourth transaction to the server; responsive to the fourth transaction, the application running on the server sends an erase transaction to an application running on the second device, where responsive to the erase transaction, the application running on the second device erases the partial medical record from the storage of the second device.

7. The system of claim 1, wherein the address of the second device is a phone number.

8. The system of claim 1, wherein the address of the second device is an email address.

9. The system of claim 1, wherein the medical information further comprises an attachment.

10. The system of claim 9, wherein the attachment is selected from a group of attachments consisting of an image, a permission letter, a travel letter, an image of an insurance card, an image of a medication label, an image of a medication label, an image of a driver's license, and an image of a passport.

11. A method for controlling and sharing medical information, the method comprising:
an application running on a first device sending a share-transaction to an application running on a sever, the share-transaction comprising a selection and an address of a second device;
responsive to the share-transaction, the application running on the server extracts medical information from a medical record into a partial medical record, sending the partial medical record from the application running on the server to a second application running on a second device;
the application running on the second device receiving the partial medical record stores the partial medical record in memory of the second device; and
upon the second application running on the second device receiving a query, the second application displays at least a portion of the partial medical record on a display of the second device.

12. The method of claim 11, whereas the selection comprises a date/time range, the application running on the server sending the date/time range to the second application and upon expiration of the date/time range, the second application erasing the partial medical record from the memory of the second device.

13. The method of claim 11, further comprising the steps of:
receiving a request to rescind sharing of the partial medical record at the application running on the first device, responsive to such, sending a stop-share-transaction to a sever, the stop-share-transaction comprising the address of the second device;
responsive to the stop-share-transaction, the application running on the server sending an erase transaction to the second application running on the second device;
the second application running on the second device receiving the upon the second application running on the second device receiving the erase transaction, the second application erases the partial medical record from the memory of the second device.

14. The method of claim 11, wherein the second device is a smartphone and the address of the second device is a phone number assigned to the smartphone.

15. Program instructions tangibly embodied in a non-transitory storage medium for providing managing of medical information, wherein the at least one instruction comprises:
computer readable instructions running on a first device for obtaining a selection and a phone number of a smartphone;
computer readable instructions running on the first device for sending a first transaction to a sever, the first transaction comprising the selection and the phone number;
computer readable instructions running on a server for receiving the first transaction and extracting a partial medical record from a medical record containing medical information specified by the selection, then sending the partial medical record to a smartphone identified by the phone number; and
computer readable instructions running on the smartphone receiving the partial medical record and storing the partial medical record in a memory of the smartphone, and upon receiving a query, displaying at least a portion of the partial medical record on a display of the smartphone.

16. The program instructions tangibly embodied in the non-transitory storage medium of claim 15, wherein:
the computer readable instructions running on the first device receiving a request to rescind sharing of the partial medical record and responsive to such, sending a stop-share-transaction to a sever, the stop-share-transaction comprising the phone number;
responsive to the stop-share-transaction, the computer readable instructions running on the server sending an erase transaction to the smartphone;
responsive to receiving the stop-share-transaction, the computer readable instructions running on the smartphone erasing the partial medical record from the memory of the smartphone.

17. The program instructions tangibly embodied in the non-transitory storage medium of claim 15, wherein the selection comprises one or more attachments selected from the group consisting of a sports permission letter, a travel permission letter, an image of a person associated with the partial medical record, an image of an insurance card, an image of a driver's license of the person, and an image of a passport of the person.

18. The program instructions tangibly embodied in the non-transitory storage medium of claim 15, wherein the selection comprises one or more items selected from the group consisting of medical conditions, allergies, medications, medical insurance information, automobile insurance information, identifying information, and a blood type.

19. The program instructions tangibly embodied in the non-transitory storage medium of claim 15, wherein the first device is a smartphone.

20. The program instructions tangibly embodied in the non-transitory storage medium of claim 15, whereas the selection comprises a date/time range and upon expiration of the date/time range the computer readable instructions running on the smartphone erasing the partial medical record.
